(19) United States
(12) Patent Application Publication
(10) Pub. No.: US 2005/0266155 A1
(43) Pub. Date: Dec. 1, 2005

(54) Apparatus and method for injecting fluid into a cable having fibrous insulation

(75) Inventor: William R. Stagi, Seattle, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Utilx Corporation

(21) Appl. No.: 11/107,410

(22) Filed: Apr. 14, 2005

Related U.S. Application Data
(63) Continuation of application No. 10/661,081, filed on Sep. 12, 2003, now abandoned.
(60) Provisional application No. 60/410,734, filed on Sep. 12, 2002.

(51) Int. Cl. B05D 5/12

(52) U.S. Cl. 427/117

(57) ABSTRACT

A method of enhancing insulative properties of a cable is provided. The method includes introducing a restorative compound into a fibrous insulation layer of a cable.

### CROSS-REFERENCE TO RELATED APPLICATIONS

This application is a continuation of application Ser. No. 10/661,081, filed Sep. 12, 2003, which claims the benefit of Provisional Application No. 60/410,734, filed Sep. 12, 2002, the disclosure is hereby expressly incorporated by reference.

### FIELD OF THE INVENTION

The present invention relates generally to electrical cables, and more particular to a method and apparatus of injecting fluid into an electrical cable having a fibrous insulation disposed therewith in.

### BACKGROUND OF THE INVENTION

Telephone cables, typically include an outer sheathing and contain a plurality of copper strands or conductors coaxially disposed in twisted pairs within the sheathing. Around each strand is an insulator which may be constructed of plastic or in some cases a layer of fibrous insulation, such as paper. Over time, the insulation layer may break down due to normal aging or due to some other cause of damage. As a result of the insulation break down, data transmission through the copper strands may be interrupted or compromised. As a result, the underground cable must be either replaced, or the insulation layer must be repaired or restored. The techniques and materials for performing a restoration process on plastic insulated (non permeable) conductor insulations is different than those processes and procedures required for restoring fibrous (permeable) conductors.

### SUMMARY OF THE INVENTION

A method of enhancing insulative properties of a cable is provided. The method includes introducing a restorative compound into a fibrous insulation layer of a cable.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is an elevation view of an apparatus for injecting fluid into a cable having fibrous insulation formed in accordance with one embodiment of the present invention, the view depicting the cable with a portion of the cable sheathing cut away;

FIG. 2 is a fragmentary view of a portion of the cable depicted in FIG. 1, wherein a portion of the cable sheathing has been cut away to show a pair of conductor wires normally enshrouded by the cable sheathing;

FIG. 3 is a fragmentary view of the portion of the cable depicted in FIG. 2, wherein a portion of the cable sheathing has been cut away to show a pair of conductor wires normally enshrouded by the cable sheathing;

FIG. 4 is a fragmentary view of the portion of the cable depicted in FIG. 2, wherein a portion of the cable sheathing has been cut away to show the pair of conductor wires normally enshrouded by the cable sheathing, the cable shown subsequent to the application of the first and second plugs, but prior to the injection of the restorative fluid;

FIG. 5 is a fragmentary view of the portion of the cable depicted in FIG. 2, wherein a portion of the cable sheathing has been cut away to show the pair of conductor wires normally enshrouded by the cable sheathing, the cable shown subsequent to the application of the first and second plugs and the restorative fluid;

FIG. 6 is a partial cross-sectional view of the cable of FIG. 2, with the sectional cut taken substantially through SECTION 6-6 of FIG. 2, showing the fibrous insulation and voids between adjacent conductor wires prior to application of the first and second plugs;

FIG. 7 is a partial cross-sectional view of the cable of FIG. 3, with the sectional cut taken substantially through SECTION 7-7 of FIG. 2, showing the voids between adjacent conductor wires filled with the first plug; and

FIG. 8 is a partial cross-sectional view of the cable of FIG. 4, with the sectional cut taken substantially through SECTION 8-8 of FIG. 4 showing the voids between adjacent conduct cables filled with the first plug, and the fibrous insulation layers filled with the second plug.

### DETAILED DESCRIPTION OF THE PREFERRED EMBODIMENT

FIGS. 1-8 illustrate one embodiment of a method and apparatus for injecting a fluid into a cable having composed of conductor strands surrounded by fibrous insulation for the restoration and/or enhancement of the insulating characteristics of the fibrous insulation. Referring to FIG. 1, generally described, in performance of the method, a first dam 22a is formed at a location spaced from a second dam 22b. The dams 22a and 22b sealingly engage the inner surface of a cable sheathing 14 and a plurality of smaller conductor wires 12 coaxially passing through a cylindrical cavity defined by the cable sheathing 14. Thus, an internal chamber 30 is created, the perimeter of the chamber 30 defined by the inner surface of the sheathing 14 and the first and second dams 22a and 22b.

The chamber 30 may then be injected with a restorative fluid. The restorative fluid is injected via a fluid pressurization system 32. The fluid pressurization system 32 includes a coupling 26 disposed in fluid communication with the chamber 30, a pump 32 for pressurizing the fluid, and a length of tubing 34 for coupling the pump 32 in fluid communication with the coupling 26. The restorative fluid wicks through the fibrous insulation layers of each conductor wire 12, thereby impeding loss of data conveyed along the conductor wires by enhancing the insulation properties of the fibrous insulation, repairing any damaged areas of insulation, and by imparting a hydrophobic characteristic to the fibrous insulation.

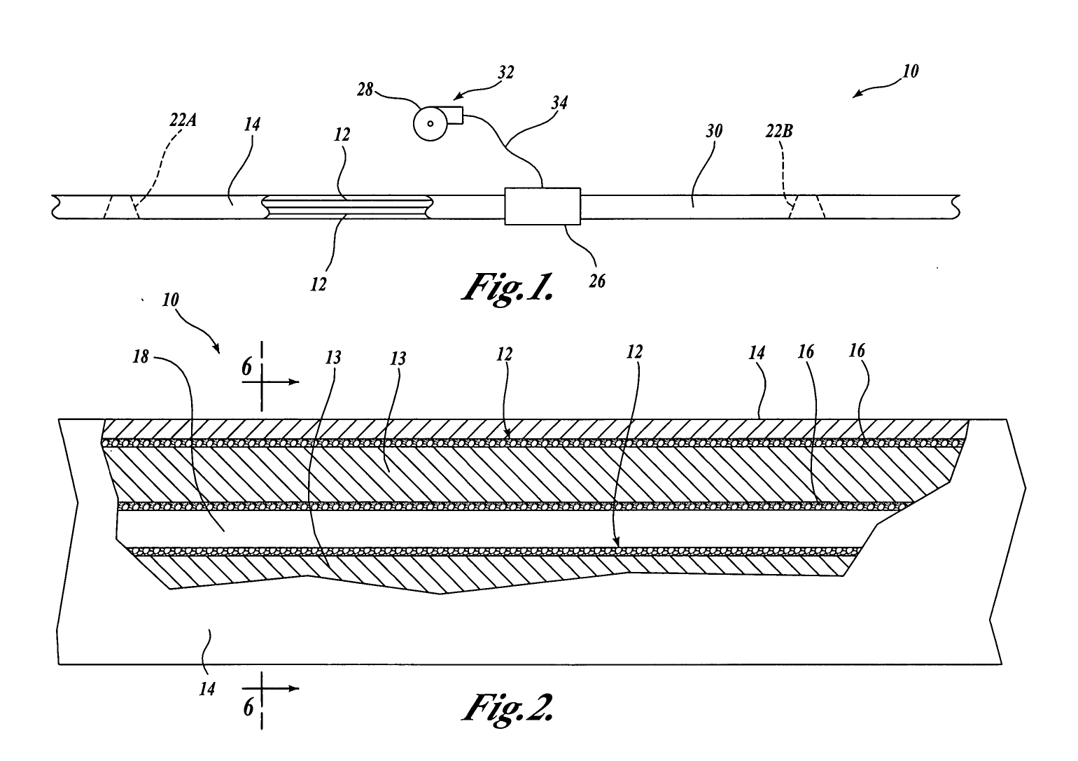

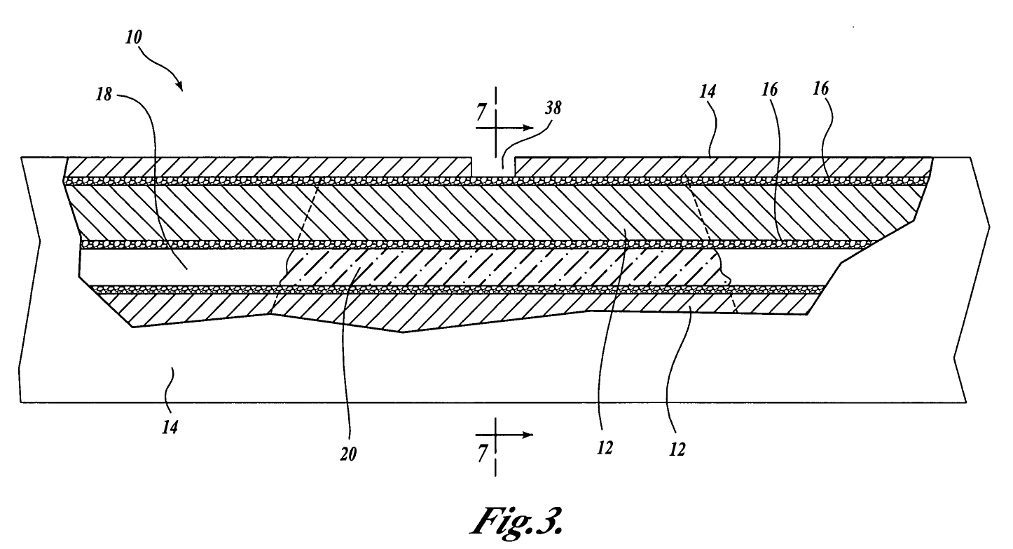

Focusing now in more detail on the illustrated embodiment and in reference to FIG. 2, a fragmentary view of a portion of the cable 10 is depicted. The cable 10 includes an outer sheathing 14 forming a long cylindrical cavity for housing a plurality of conductor wires 12 therein. Although the conductor wires are illustrated as parallel, it should be noted other configurations, such as twisted pairs of conductor wires, are also within the scope of the present invention. The sheathing 14 may be formed from any suitable sheathing material know in the art, such as a lead sheathing having a plurality of copper strands coaxially disposed within the sheathing. The conductor wires 12 are formed from a conductive core 13, such as copper wire, jacketed by a fibrous insulative material 16, such as pulp or paper.

Although it should be apparent to one skilled in the art that the invention is suitable for use with may different cable types, some illustrative examples of suitable cables are a 1″ outside diameter cable having a plastic/corrugated stainless steel-sheath housing 100 pairs of paper-insulated copper wires, each wire having a diameter of 0.025″, as manufactured by Anaconda. Another illustrative example is a 1.75″ outside diameter cable having a lead-sheath housing 100 pairs of paper-insulated copper wires, each wire having a diameter of 0.030″. Yet another illustrative example is a 2″ outside diameter cable having a lead-sheath housing 600 pairs of paper-insulated copper wires, each wire having a diameter of 0.020″.

Referring now to FIG. 6, although the conductor wires 12 are tightly packed within the sheathing 14, voids 18 are formed between adjacent conductor wires 12. The voids 18 provide a flow path for water oriented longitudinally along the length of the cable 10. Further, the voids 18 also provide a path for the flow of any restorative fluid injected within the cable 10, thus hampering the ability of the user to force the restorative fluid under pressure into the insulation layers 16 of the conductor wires 12.

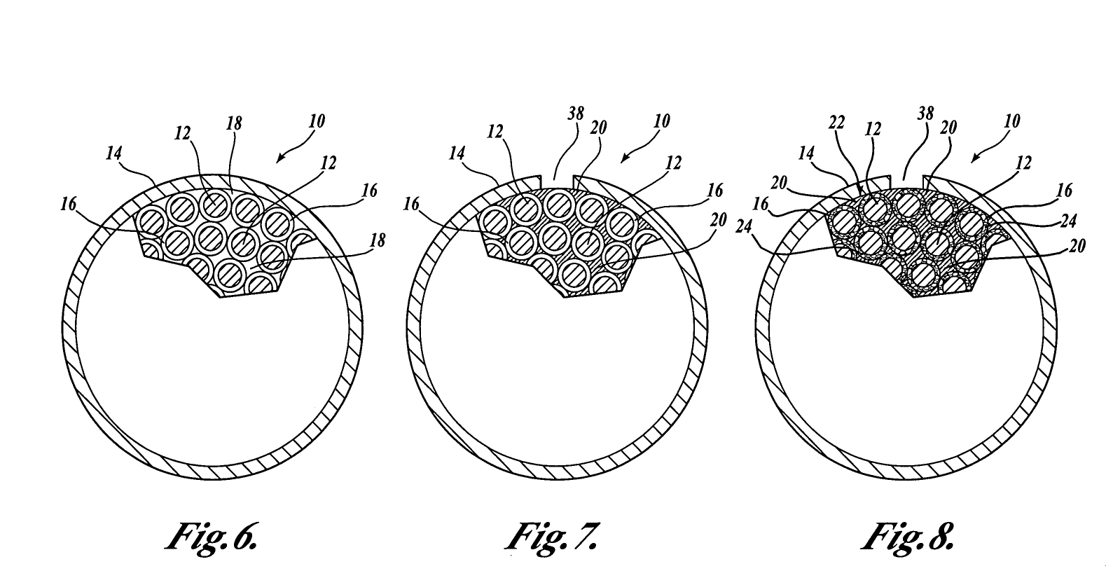

Referring now to FIGS. 3 and 7, the formation of a primary plug 20 within the voids 18 will be discussed in further detail. To form the primary plug 20, an incision 38 is made in the sheathing 14. Within the incision 38, a suitable well known blocking compound, such as SCOTCHCAST™ Encapsulating and Blocking Compound (part number 4407), includes a prepolymer and a polyol mixture manufactured by 3M, is injected under pressure or poured through the incision 38 and into the interior of the sheathing 14. Under normal and intended operating conditions, such blocking compounds do not wick into the fibers.

The blocking compound enters the voids 18 present between adjacent conductor wires 12 and solidifies to form the primary plug 20. The primary plug 20 fills the voids 18, impeding the passage of a fluid through the voids 18. However, the blocking compound does not sufficiently enter the fibrous insulation layer 16 which jackets the central cores 13 since the blocking compound does not “wet” nor is it wicked up by the fibrous insulation 16 of the conductor wires 12, therefore necessitating the formation of a secondary plug to impede the passage of a fluid through the fibrous insulation layer 16.

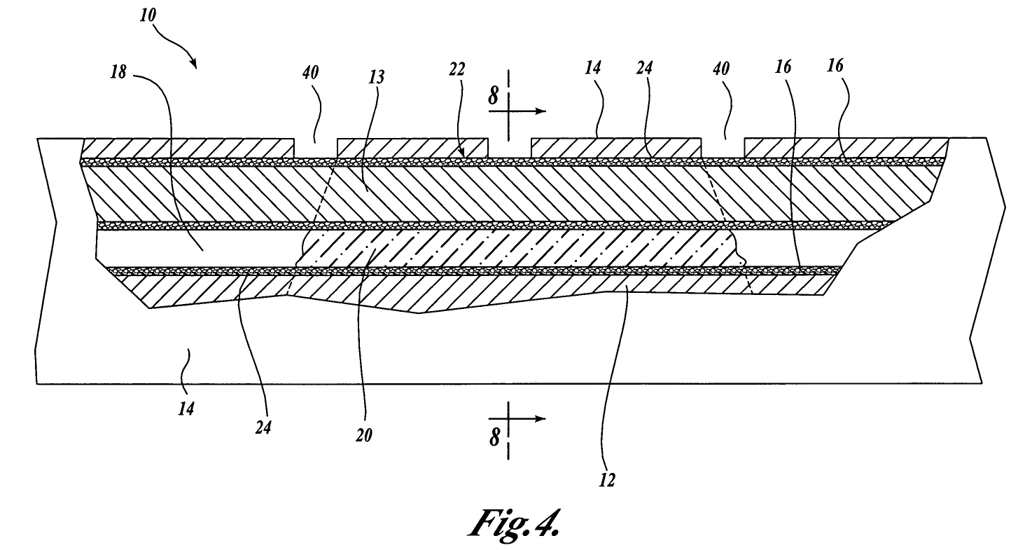

Referring now to FIGS. 4 and 8, the formation of the secondary plug 24 for blocking the passage of fluid through the space occupied by the fibrous insulation layer 16 of the conductor wires 12 will be described in further detail. To form the secondary plug 24, a second suitable blocking compound, such as Damming Compound 30 (DC30), comprised of a silicone fluid manufactured by Dow Corning is injected under pressure or poured in proximity to at least one of the ends of the primary plug 20 through a pair of second incisions 40 in the sheath 14.

Alternately, the sheath 14 may be removed in vicinity of the primary plug and the blocking compound poured around the primary plug. The second blocking compound is selected so as to be amenable to being wicked along the fibrous insulation layer 16, wherein it then solidifies, forming the secondary plug 24. The secondary plug 24, once solidified, seals the passage of a fluid through the fibrous insulation layers 16. Thus, it should be apparent to one skilled in the art, that the primary plug 20 seals the voids 18 formed between adjacent conductor wires 12, while the secondary plug 24 seals the leak paths present in the fibrous insulation layer 16. Therefore, in the aggregate, the primary and secondary plugs 20 and 24 form a pressure tight dam 22 that impedes the movement of fluids longitudinally passed the dam 22, forming a pressure sealing wall comprised of the first and second plugs 20 and 24, and the cores 13 of the conductor wires 12.

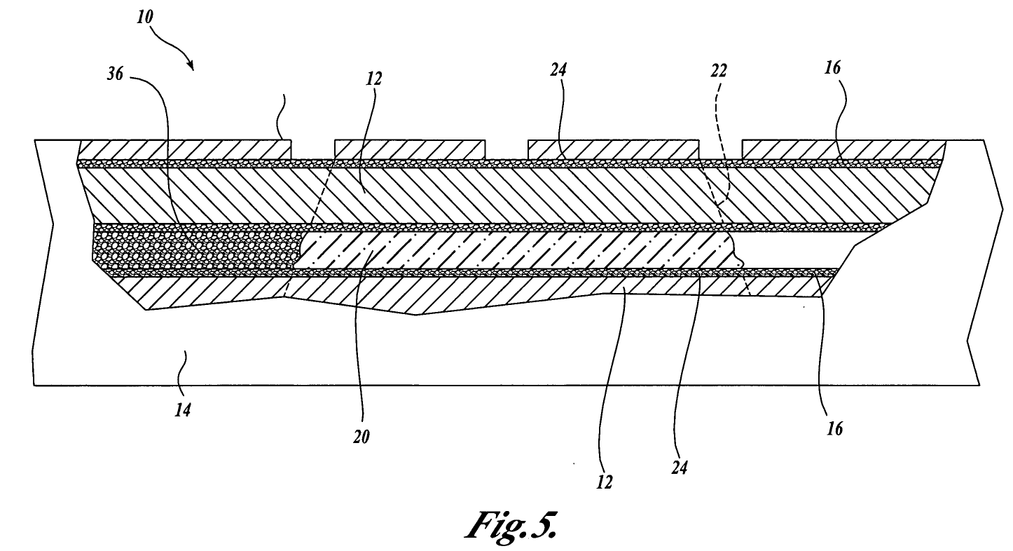

Referring to FIGS. 1 and 5, by forming a first dam 22a spaced from a second dam 22b within the cable 10, a pressure vessel 30 is formed, defined at one end by the first dam 22a, at an opposite end by the second dam 22b, and by the inner surface of the sheath 14. A well know restorative fluid 36 may be injected through a pressurization system 32. The fluid pressurization system 32 includes a coupling 26 disposed in fluid communication with the chamber 30, a pump 32 for pressurizing the fluid 36, and a length of tubing 34 for coupling in fluid communication the pump 32 with the coupling 26.

The restorative fluid 36 flows through and fills the voids as well as the interstices between the fibrous elements of the insulation layers of the conductor wires. The restorative fluid 36 enhances the insulation properties of the aged fibrous insulation, and protects it from water, thus impeding loss of data conveyed along the conductor wires. The restorative fluid 36 is pumped at sufficient pressure, such as anywhere from 0 to 200 psi, with a preferred value of 80 psi, to force the restorative fluid into the fibrous insulation layers 16 through out the entire length of the cable spanning between the two dams. While one embodiment of the present application is described as pumping restorative fluid 36 at a pressure, the application is not intended to be so limited. As a second, non-limiting example, the restorative fluid 36 may be transported through the length of the cable by the wicking properties of the fibrous insulation. Accordingly, non-pressurized system is also within the scope of the present application.

While the preferred embodiment of the invention has been illustrated and described, it will be appreciated that various changes can be made therein without departing from the spirit and scope of the invention. As a non-limiting example, a cable having only one dam is also within the scope of the present invention. In that regard, a damming compound, such as Dow Corning Tough Gel 3-4207, is injected into the cable. The damming compound is suitably a thin fluid, i.e., viscous fluid, that wicks into porous materials, such as paper insulation. The damming fluid cures into a gel before it drains from the dam area. As a result, a primary dam is not required. In another embodiment, a heating element may be wrapped around the cable while the damming fluid is injected into the cable to increase the reaction time.

1. A method of enhancing insulative properties of a cable, comprising:
(a) introducing a restorative compound into a fibrous insulation layer of a cable.
